(19) United States
(12) Patent Application Publication
(10) Pub. No.: US 2017/0156181 A1
(43) Pub. Date: Jun. 1, 2017

(54) COOKING APPARATUS

(71) Applicants: GUANGDONG MIDEA KITCHEN APPLIANCES MANUFACTURING CO., LTD., Foshan (CN); MIDEA GROUP CO., LTD., Foshan (CN)

(72) Inventor: MO DAM JOO, Foshan (CN)

(21) Appl. No.: 15/196,969

(22) Filed: Jun. 29, 2016

(30) Foreign Application Priority Data
Nov. 30, 2015 (CN) 201520979056.6

(51) Int. Cl. H05B 6/64; H05B 6/80

(52) U.S. Cl. CPC H05B 6/6485; H05B 6/6473; H05B 6/80

(57) ABSTRACT

The present invention provides a cooking apparatus, comprising: an outer housing, a cavity, an upper heat source, a lower heating element, a microwave device and a hot air system, wherein the upper heat source is arranged on the top plate of the cavity; the lower heating element is arranged on a bottom plate of the U-shaped board of the cavity; the microwave device is arranged on one side plate of the U-shaped board; and the hot air system is arranged on the other side plate of the U-shaped board. In the cooking apparatus provided by the present invention, when rapid heating of food is needed, the upper heat source, the lower heating element, the hot air system and the microwave device are enabled at the same time, and the upper heat source, the lower heating element and the microwave device heat the food. (FIG. 1)

### CROSS-REFERENCE TO RELATED APPLICATIONS

This application claims priority to Chinese Application No. 201520979056.6 filed on Nov. 30, 2015, the disclosure of which is hereby incorporated herein by reference.

### STATEMENT REGARDING FEDERALLY SPONSORED RESEARCH OR DEVELOPMENT

Not Applicable.

### BACKGROUND

Field of the Invention

The present invention relates to the field of household appliances, and in particular, to a cooking apparatus.

Background of the Invention

At present, in cooking apparatuses sold on the market, a single or double heat source system is adopted for heating food. This heating mode can meet a user's general food cooking requirement. However, sometimes a user needs to cook food in a short time, and the existing cooking apparatuses cannot achieve the purpose of rapid heating.

### SUMMARY

In order to solve at least one of the above technical problems, an object of the present invention is to provide a cooking apparatus capable of achieving rapid cooking effect.

In view of this, the present invention provides a cooking apparatus, including: an outer housing; a cavity, which is an accommodating cavity composed of a U-shaped board, a top plate and a rear plate with a front end being open for accommodating food; an upper heat source, which is arranged on the top plate and used for radiating heat energy into the accommodating cavity; a lower heating element, which is arranged on a bottom plate of the U-shaped board and used for radiating heat energy into the accommodating cavity; a microwave device, which is arranged on one side plate of the U-shaped board and used for transmitting microwaves into the accommodating cavity; and a hot air system, which is arranged on the other side plate of the U-shaped board and used for transmitting hot air into the accommodating cavity.

In the cooking apparatus provided by the present invention, when rapid heating of food is needed, the upper heat source, the lower heating element, the hot air system and the microwave device are enabled at the same time, and the upper heat source, the lower heating element and the microwave device heat the food simultaneously, so that the food achieves the needed cooking effect rapidly, thus saving cooking time, and improving using comfort of the product. In addition, the hot air system causes air within the accommodating cavity to flow, to guarantee uniform distribution of heat within the accommodating cavity, thus ensuring that the food is heated uniformly, i.e. avoiding the phenomenon that local overheating of the food causes poor cooking effect of the food, thereby increasing market competitiveness of the product.

Specifically, the cooking apparatus in the prior art adopts a single or double heat source system for heating food, and cannot achieve the purpose of rapid heating; whereas in the cooking apparatus provided by the present invention, when rapid heating of food is needed, the upper heat source, the lower heating element and the microwave device heat the food simultaneously, and meanwhile, the hot air system causes air within the accommodating cavity to flow, so that the food achieves the needed cooking effect rapidly, thus saving cooking time, and the hot air system guarantees uniform distribution of heat within the accommodating cavity, thus ensuring that the food is heated uniformly, i.e. avoiding the phenomenon that local overheating of the food causes poor cooking effect of the food, thus improving using comfort of the product, thereby increasing market competitiveness of the product.

In addition, the cooking apparatus in the above embodiment provided by the present invention can further have the following additional technical features:

In the above technical solution, the upper heat source includes: an upper heating element, which is arranged on the top plate and used for radiating heat energy into the accommodating cavity; and a halogen heating tube, which is arranged on the top plate and used for radiating heat energy into the accommodating cavity.

In the technical solution, the upper heating element can fully bake the surface of the food rapidly, and the halogen heating tube can heat the interior of the food, to ensure uniform heating of the interior and exterior of the food, so that the food achieves the needed cooking effect rapidly, thus saving cooking time and improving using comfort of the product.

In any technical solution described above, the cooking apparatus further includes a control device, which is connected with the lower heating element, the upper heating element and the microwave device and used for controlling the lower heating element, the upper heating element and the microwave device to be enabled intermittently.

In the technical solution, the upper heating element and the lower heating element can heat the surface layer of the food, and microwaves cause movement of molecules inside the food to generate heat so as to heat the food. However, the surface layer of the food is easily fully baked, and the mouthfeel of the food heated by microwaves is less desirable. With the control device, on the one hand, the upper heating element and the lower heating element work intermittently, to avoid the phenomenon that overheating of the surface layer of the food results in poor mouthfeel or overheating of the food; on the other hand, with intermittent operation of the microwave device, while rapid heating of the food is ensured, the mouthfeel of the food is ensured, and using comfort of the product is improved, thereby increasing market competitiveness of the product.

In any technical solution described above, the upper heating element and the halogen heating tube are arranged on two sides of the top plate, and the upper heating element is a metal heating tube.

In the technical solution, arranging the upper heating element and the halogen heating tube on two sides of the top plate ensures uniform heat distribution of the accommodating cavity, thus ensuring uniform heating of the food, and their simultaneous heating improves heating efficiency of the cooking apparatus; in addition, it avoids the phenomenon that the cooking apparatus cannot be used when one of the upper heating element and the halogen heating tube is damaged, thus improving using comfort of the product, thereby increasing market competitiveness of the product.

In any technical solution described above, the upper heating element is U-shaped; and one end of the halogen heating tube projects into the recess of the U shape.

In the technical solution, the arrangement position and shape of the upper heating element and the halogen heating tube ensure uniform heat distribution of the accommodating cavity, thus ensuring uniform heating of the food, and their simultaneous heating improves heating efficiency of the cooking apparatus; in addition, it avoids the phenomenon that the cooking apparatus cannot be used when one of the upper heating element and the halogen heating tube is damaged, thus improving using comfort of the product, thereby increasing market competitiveness of the product.

In any technical solution described above, the lower heating element is a metal heating tube.

In the technical solution, the metal heating tube can fully bake the surface of the food rapidly, and is used in combination with the halogen heating tube, to ensure uniform heating of the interior and exterior of the food, so that the food achieves the needed cooking effect rapidly, thus saving cooking time and improving using comfort of the product.

In any technical solution described above, the cooking apparatus further includes a metal baking pan, which is arranged within the accommodating cavity.

In the technical solution, the baking pan absorbs heat radiation produced by the lower heating element and generates heat, to heat the outer layer of the bottom of the food; meanwhile, the food also absorbs heat radiation produced by the lower heating element and is heated; in this way, uniform heating of the bottom of the food is guaranteed, and thus cooking effect of the food is ensured, thereby improving using comfort of the product, and increasing market competitiveness of the product.

In any technical solution described above, the lower heating element is just beneath the metal baking pan.

In the technical solution, the metal baking pan more easily absorbs heat energy radiated by the lower heating element, to ensure that the bottom of the food can be heated, and ensure uniform heating of the interior and exterior of the food, so that the food achieves the needed cooking effect rapidly, thus saving cooking time and improving using comfort of the product.

In any technical solution described above, the lower heating element is in the middle of the metal baking pan.

In the technical solution, the middle part of the food is most difficult to heat, and with the lower heating element being located in the middle of the metal baking pan, the middle part of the food can be heated, and uniform heating of the interior and exterior of the food is ensured, so that the food achieves the needed cooking effect rapidly, thus saving cooking time and improving using comfort of the product.

In any technical solution described above, the hot air system is arranged on the left side plate of the U-shaped board, and the microwave device is arranged on the right side plate of the U-shaped board.

Additional aspects and advantages of the present invention will become apparent from the description below, or be learned through practice of the present invention.

### BRIEF DESCRIPTION OF THE DRAWINGS

The above and/or additional aspects and advantages of the present invention will become apparent and easily understood from the description of the embodiments in conjunction with accompanying drawings below, in which:

FIG. 1 is a partial stereoscopic structure diagram of a cooking apparatus of the present invention (an outer housing removed).

FIG. 2 is a top structure diagram of the structure shown in FIG. 1 with a top plate removed;

FIG. 3 is a structure diagram of the structure shown in FIG. 2 with an upper heating element and a metal baking pan removed; and

FIG. 4 is a working state diagram of the cooking apparatus of the present invention.

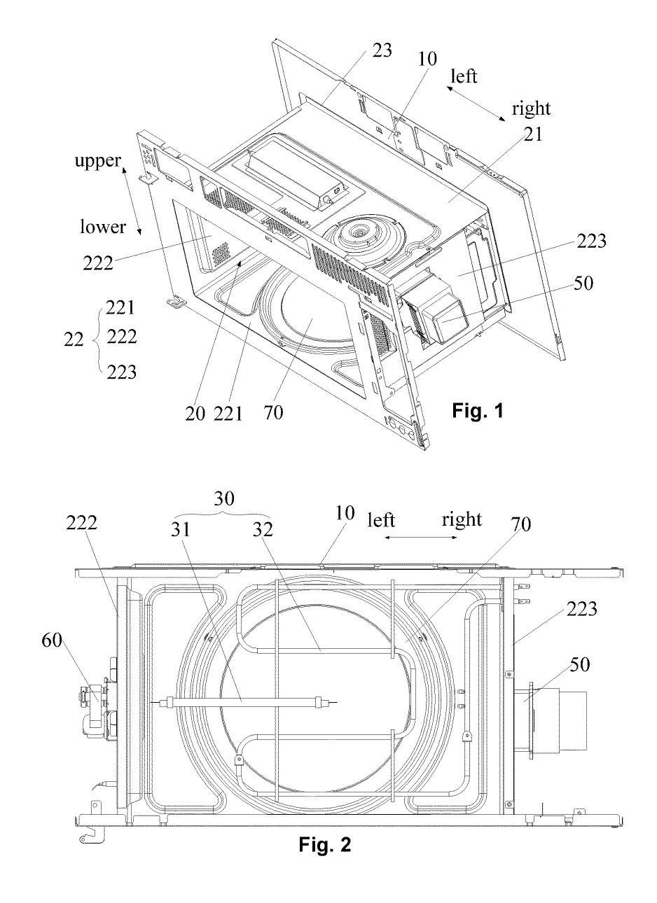

Corresponding relations between reference numerals and component names in FIGS. 1 to 3: 10: outer housing, 20: cavity, 21: top plate, 22: U-shaped plate, 221: bottom plate, 222: left side plate, 223: right side plate, 23: rear plate, 30: upper heat source, 31: halogen heating tube, 32: upper heating element, 40: lower heating element, 50: microwave device, 60: hot air system, 70: metal baking pan.

### DETAILED DESCRIPTION

In order to understand the above objects, features and advantages of the present invention more clearly, the present invention is further described in detail in conjunction with the accompanying drawings and specific embodiments. It needs to be noted that the embodiments of the present application and features in the embodiments can be combined with each other without conflict.

Many specific details are set forth in the description below to facilitate full understanding of the present invention. However, the present invention may also be implemented in other ways different from those described here. Thus, the protection scope of the present invention is not restricted by the specific embodiments disclosed below.

A cooking apparatus according to some embodiments of the present invention is described below with reference to FIGS. 1 to 4.

As shown in FIGS. 1 to 3, the cooking apparatus provided by the present invention includes: an outer housing 10, a cavity 20, an upper heat source 30, a lower heating element 40, a microwave device 50 and a hot air system 60.

Specifically, the cavity 20 is an accommodating cavity composed of a U-shaped board 22, a top plate 21 and a rear plate 23 with a front end being open for accommodating food, and the cavity 20 is located within the outer housing 10; the upper heat source 30 is arranged on the top plate 21 and used for radiating heat energy into the accommodating cavity; the lower heating element 40 is arranged on a bottom plate 221 of the U-shaped board 22 of the cavity 20 and used for radiating heat energy into the accommodating cavity; the microwave device 50 is arranged on one side plate of the cavity 20 and used for transmitting microwaves into the accommodating cavity; and the hot air system 60 is arranged on the other side plate of the cavity 20 and used for transmitting hot air into the accommodating cavity.

In the cooking apparatus provided by the present invention, when rapid heating of food is needed, the upper heat source 30, the lower heating element 40, the hot air system 60 and the microwave device 50 are enabled at the same time, and the upper heat source 30, the lower heating element 40 and the microwave device 50 heat the food simultaneously, so that the food achieves the needed cooking effect rapidly, thus saving cooking time, and improving using comfort of the product. In addition, the hot air system 60 causes air within the accommodating cavity to flow and heats the air within the accommodating cavity, to guarantee uniform distribution of heat within the accommodating cavity, thus ensuring that the food is heated uniformly, i.e. avoiding the phenomenon that local overheating of the food causes poor cooking effect of the food, thereby increasing market competitiveness of the product.

In an embodiment of the present invention, as shown in FIG. 2, the upper heat source 30 includes an upper heating element 32 and a halogen heating tube 31.

Specifically, the upper heating element 32 is arranged on the top plate 21 and used for radiating heat energy into the accommodating cavity; and the halogen heating tube 31 is arranged on the top plate 21 and used for radiating heat energy into the accommodating cavity.

In the embodiment, the upper heating element 32 can fully bake the surface of the food rapidly, and the halogen heating tube 31 can heat the interior of the food, and with their combined action, not only is cooking efficiency improved, but also uniform heating of the interior and exterior of the food is ensured, so that the food achieves the needed cooking effect rapidly, thus saving cooking time and improving using comfort of the product.

In an embodiment of the present invention, the cooking apparatus further includes: a control device (not shown in the figures), which is connected with the lower heating element 40, the upper heating element 32 and the microwave device 50, and as shown in FIG. 4, used for controlling the lower heating element 40, the upper heating element 32 and the microwave device 50 to be enabled intermittently.

In the embodiment, the upper heating element 32 and the lower heating element 40 can heat the surface layer of the food, and microwaves cause movement of molecules inside the food to generate heat so as to heat the food. However, the surface layer of the food is easily fully baked, and the mouthfeel of the food heated by microwaves is less desirable. With the control device, on the one hand, the upper heating element 32 and the lower heating element 40 work intermittently, to avoid the phenomenon that overheating of the surface layer of the food results in poor mouthfeel or overheating of the food; on the other hand, with intermittent operation of the microwave device 50, while rapid heating of the food is ensured, the mouthfeel of the food is ensured, and using comfort of the product is improved, thereby increasing market competitiveness of the product.

In an embodiment of the present invention, as shown in FIG. 2, the upper heating element 32 and the halogen heating tube 31 are arranged on two sides of the top plate 21 of the cavity 20, and the upper heating element 32 is a metal heating tube.

In the embodiment, arranging the upper heating element 32 and the halogen heating tube 31 on two sides of the top plate 21 ensures uniform heat distribution of the accommodating cavity, thus ensuring uniform heating of the food, and their simultaneous heating improves heating efficiency of the cooking apparatus; in addition, it avoids the phenomenon that the cooking apparatus cannot be used when one of the upper heating element 32 and the halogen heating tube 31 is damaged, thus improving using comfort of the product, thereby increasing market competitiveness of the product.

In an embodiment of the present invention, as shown in FIGS. 1 to 3, the upper heating element 32 is U-shaped; and one end of the halogen heating tube 31 projects into the recess of the U shape.

In the embodiment, the arrangement position and shape of the upper heating element 32 and the halogen heating tube 31 ensure uniform heat distribution of the accommodating cavity, thus ensuring uniform heating of the food, and their simultaneous heating improves heating efficiency of the cooking apparatus; in addition, it avoids the phenomenon that the cooking apparatus cannot be used when one of the upper heating element 32 and the halogen heating tube 31 is damaged, thus improving using comfort of the product, thereby increasing market competitiveness of the product.

In an embodiment of the present invention, the lower heating element 40 is a metal heating tube.

In the embodiment, the metal heating tube can fully bake the surface of the food rapidly, and is used in combination with the halogen heating tube 31, to ensure uniform heating of the interior and exterior of the food, so that the food achieves the needed cooking effect rapidly, thus saving cooking time and improving using comfort of the product.

In an embodiment of the present invention, as shown in FIGS. 1 and 2, the cooking apparatus further includes a metal baking pan 70, and the metal baking pan 70 is arranged within the accommodating cavity.

In the embodiment, the baking pan absorbs heat radiation produced by the lower heating element 40 and generates heat, to heat the outer layer of the bottom of the food; meanwhile, the food also absorbs heat radiation produced by the lower heating element 40 and is heated; in this way, uniform heating of the bottom of the food is guaranteed, and thus cooking effect of the food is ensured, thereby improving using comfort of the product, and increasing market competitiveness of the product.

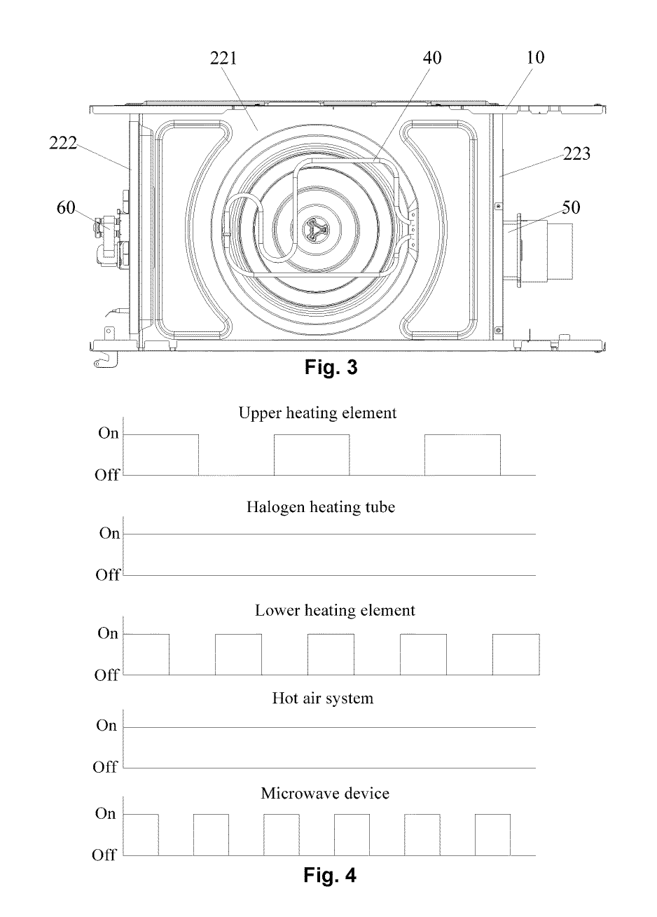

In an embodiment of the present invention, as shown in FIGS. 2 and 3, the lower heating element 40 is just beneath the metal baking pan 70.

In the embodiment, the metal baking pan 70 more easily absorbs heat energy radiated by the lower heating element 40, to ensure that the bottom of the food can be heated, and ensure uniform heating of the interior and exterior of the food, so that the food achieves the needed cooking effect rapidly, thus saving cooking time and improving using comfort of the product.

In an embodiment of the present invention, as shown in FIG. 3, the lower heating element 40 is in the middle of the metal baking pan 70.

In the embodiment, the middle part of the food is most difficult to heat, and with the lower heating element 40 being located in the middle of the metal baking pan 70, the middle part of the food can be heated, and uniform heating of the interior and exterior of the food is ensured, so that the food achieves the needed cooking effect rapidly, thus saving cooking time and improving using comfort of the product.

In a specific embodiment of the invention, the hot air system is arranged on the left side plate 222 of the U-shaped board 22, and the microwave device 50 is arranged on the right side plate 223 of the U-shaped board 22.

To sum, up, in the cooking apparatus provided by the present invention, when rapid heating of the food is needed, the upper heat source, the lower heating element, the hot air system and the microwave device are enabled at the same time, and the upper heat source, the lower heating element and the microwave device heat the food simultaneously, so that the food achieves the needed cooking effect rapidly, thus saving cooking time, and improving using comfort of the product. In addition, the hot air system causes air within the accommodating cavity to flow and heats the air within the accommodating cavity, to guarantee uniform distribution of heat within the accommodating cavity, thus ensuring that the food is heated uniformly, i.e. avoiding the phenomenon that local overheating of the food causes poor cooking effect of the food, thereby increasing market competitiveness of the product.

Specifically, the cooking apparatus in the prior art adopts a single or double heat source system for merely heating food, and cannot achieve the purpose of rapid heating; whereas in the cooking apparatus provided by the present invention, when rapid heating of food is needed, the upper heat source, the lower heating element and the microwave device heat the food simultaneously, and meanwhile, the hot air system causes air within the accommodating cavity to flow, so that the food achieves the needed cooking effect rapidly, thus saving cooking time, and the hot air system guarantees uniform distribution of heat within the accommodating cavity, thus ensuring that the food is heated uniformly, i.e. avoiding the phenomenon that local overheating of the food causes poor cooking effect of the food, thus improving using comfort of the product, thereby increasing market competitiveness of the product.

In description of the present invention, it needs to be understood that orientation or position relations denoted by the terms “upper”, “lower”, “left”, “right” and the like are orientation or position relations based on illustration in the figures, are intended to facilitate describing the present invention and simplifying description, instead of indicating or implying that the denoted devices or units necessarily have specific directions and are constructed and operated in specific orientations, and thus they cannot be understood as limiting the present invention.

In description of the specification, description of the terms “an embodiment”, “some embodiments”, “specific embodiment” and the like means that a specific feature, structure, material or characteristic described in conjunction with the embodiment or example is included in at least one embodiment or example of the present invention. In the description, schematic expressions of the above terms refer not necessarily to the same embodiment(s) or example(s). Moreover, the specific feature, structure, material or characteristic described can be combined in a suitable manner in any one or more embodiments or examples.

Described above are merely preferred embodiments of the present invention, which are not used for limiting the present invention, and to those skilled in the art, various modifications and changes may be made to the present invention. Any modification, equivalent substitution, improvement and the like made within the spirit and principle of the present invention shall be encompassed within the protection scope of the present invention.

What is claimed is:

1. A cooking apparatus, comprising:
an outer housing;
a cavity, which is an accommodating cavity composed of a U-shaped board, a top plate and a rear plate with a front end being open for accommodating food;
an upper heat source, which is arranged on the top plate and used for radiating heat energy into the accommodating cavity;
a lower heating element, which is arranged on a bottom plate of the U-shaped board and used for radiating heat energy into the accommodating cavity;
a microwave device, which is arranged on one side plate of the U-shaped board and used for transmitting microwaves into the accommodating cavity; and
a hot air system, which is arranged on the other side plate of the U-shaped board and used for transmitting hot air into the accommodating cavity.

2. The cooking apparatus according to claim 1, wherein the upper heat source comprises:
an upper heating element, which is arranged on the top plate and used for radiating heat energy into the accommodating cavity; and
a halogen heating tube, which is arranged on the top plate and used for radiating heat energy into the accommodating cavity.

3. The cooking apparatus according to claim 2, further comprising:
a control device, which is connected with the lower heating element, the upper heating element and the microwave device and used for controlling the lower heating element, the upper heating element and the microwave device to be enabled intermittently.

4. The cooking apparatus according to claim 2, wherein the upper heating element and the halogen heating tube are arranged on two sides of the top plate, and the upper heating element is a metal heating tube.

5. The cooking apparatus according to claim 4, wherein the upper heating element is U-shaped; and one end of the halogen heating tube projects into the recess of the U shape.

6. The cooking apparatus according to claim 1, wherein the lower heating element is a metal heating tube.

7. The cooking apparatus according to claim 1, further comprising a metal baking pan, which is arranged within the accommodating cavity.

8. The cooking apparatus according to claim 7, wherein the lower heating element is just beneath the metal baking pan.

9. The cooking apparatus according to claim 8, wherein the lower heating element is in the middle of the metal baking pan.

10. The cooking apparatus according to claim 7, wherein the hot air system is arranged on the left side plate of the U-shaped board, and the microwave device is arranged on the right side plate of the U-shaped board.

11. The cooking apparatus according to claim 2, further comprising a metal baking pan, which is arranged within the accommodating cavity.

12. The cooking apparatus according to claim 3, further comprising a metal baking pan, which is arranged within the accommodating cavity.

13. The cooking apparatus according to claim 4, further comprising a metal baking pan, which is arranged within the accommodating cavity.

14. The cooking apparatus according to claim 5, further comprising a metal baking pan, which is arranged within the accommodating cavity.

15. The cooking apparatus according to claim 6, further comprising a metal baking pan, which is arranged within the accommodating cavity.
